(19) United States
(12) Patent Application Publication
(10) Pub. No.: US 2012/0261003 A1
(43) Pub. Date: Oct. 18, 2012

(54) Toilet Valve Adapter

(75) Inventors: Tom Stout, San Jose, CA (US); Tuan Le, Diamond Bar, CA (US)

(73) Assignee: Fluidmaster, Inc., San Juan Capistrano, CA (US)

(21) Appl. No.: 13/447,911

(22) Filed: Apr. 16, 2012

Related U.S. Application Data
(60) Provisional application No. 61/476,673, filed on Apr. 18, 2011.

(51) Int. Cl. F16K 51/00

(52) U.S. Cl. 137/315.01

(57) ABSTRACT

A toilet valve adapter, including: a hollow body having a lower end dimensioned to be received into an outlet and an upper end dimensioned to support a flush valve thereon; a flange extending radially outwards from the hollow circular body; a gasket on the underside of the flange; and prongs projecting radially outwards from the lower end of the hollow circular body.

### RELATED APPLICATION

The present application claims priority to U.S. Provisional Patent Application 61/476,673, filed Apr. 18, 2011, of the same title, incorporated herein by reference in its entirety.

### BACKGROUND OF THE INVENTION

When replacing a flush valve in a toilet, it is most often required that the existing valve must be removed. This requires additional work, a skilled person to perform the work, and the potential to introduce new problems. Additional work may include removing the tank in order to have access to the mounting features of the existing flush valve. The potential issues include a high likelihood of encountering problems with the existing seal, fit issues of the new valve, and requirement for parts not included with the new valve. It is desired to have an adapter that seals to and fits the existing flush valve body without requiring tools. Additionally, it should fit a wide range of valves.

The majority of replacement valves require removal of the existing valve and tank. Valves that, do fit existing valves have a limited range they may be applied, do not fit all geometries (such as valves with square overflow tubes) and additionally may restrict performance of the toilet. There are a wide range of geometries and bore sizes of valves currently on the market.

### SUMMARY OF THE INVENTION

The present adapter addresses the issue of performance as well as fitting a larger variety of existing valves. For example, the present adapter can securely mount to the inner bore of the existing valve body; without requiring tools. It specifically adapts to a wide range bore sizes, valve geometries and seal surface geometries.

The present adapter uses uniquely designed prongs to mechanically grab onto the inner bore of a variety of sizes of valves. Additionally, it leverages a traditional gasket seal to create a seal between it and the existing valve body. It is able to securely mount even to the smooth inner bore of the valve. The clips or prongs to achieve this may be teeth or spikes to bite into the valve body material (whether it is plastic, brass, or other). Preferably, there is an automatic adjustment range of the teeth that gives a consistent bite, regardless of the inner bore variation. There may be different numbers of teeth and geometries to achieve this. One implementation includes bent metal tabs with pointed teeth that are sprung towards the inner bore wall. Lead-in features of the adapter and clips allow the user to easily install the adapter by simply pressing it down onto the existing valve body. The geometry and/or spring of the teeth securely hold the adapter in place. Additional features can allow for easy removal, indication of proper gasket sealing, and proper orientation of the adapter relative to the existing flush valve in order to not block the overflow functionality.

### BRIEF DESCRIPTION OF THE DRAWINGS

FIG. 1 is a bottom plan view of the adapter.

FIG. 2 is a front elevation view of the adapter.

FIG. 3 is a sectional front elevation view of the adapter.

FIG. 4 is a top perspective view of the adapter.

FIG. 5 is a side elevation view of the adapter.

FIG. 6 is a sectional side elevation view of the adapter received into an outlet.

FIG. 7A is a side elevation view of the adapter with a flush valve positioned thereon.

FIG. 7B is an exploded view corresponding to FIG. 7A.

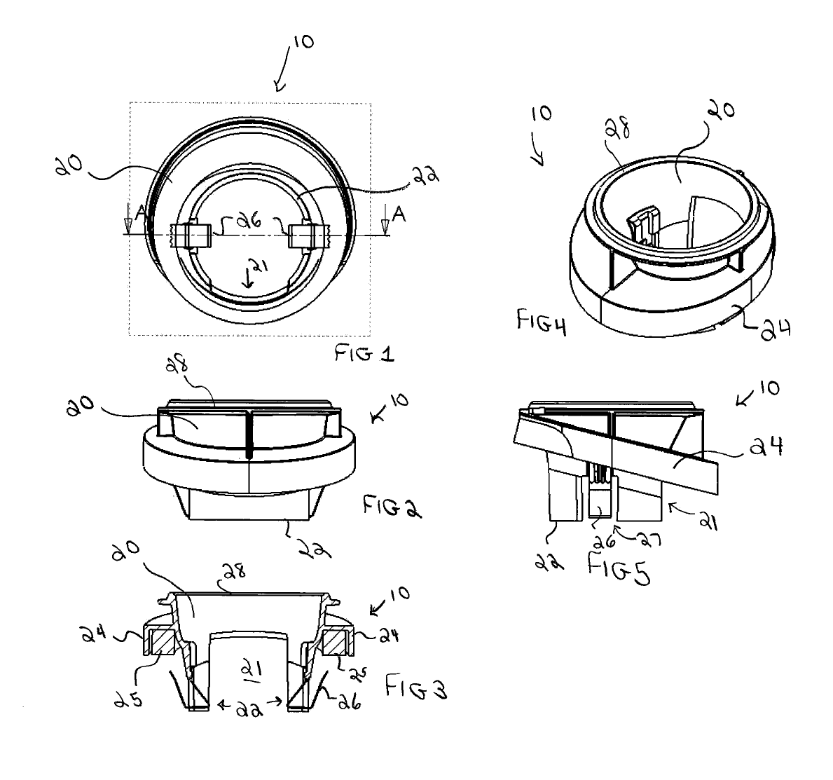

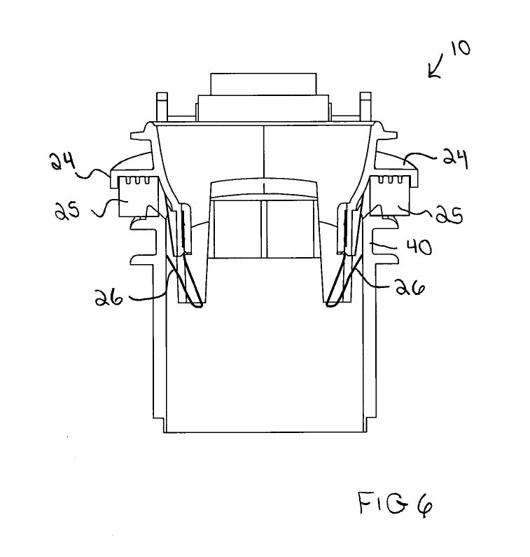

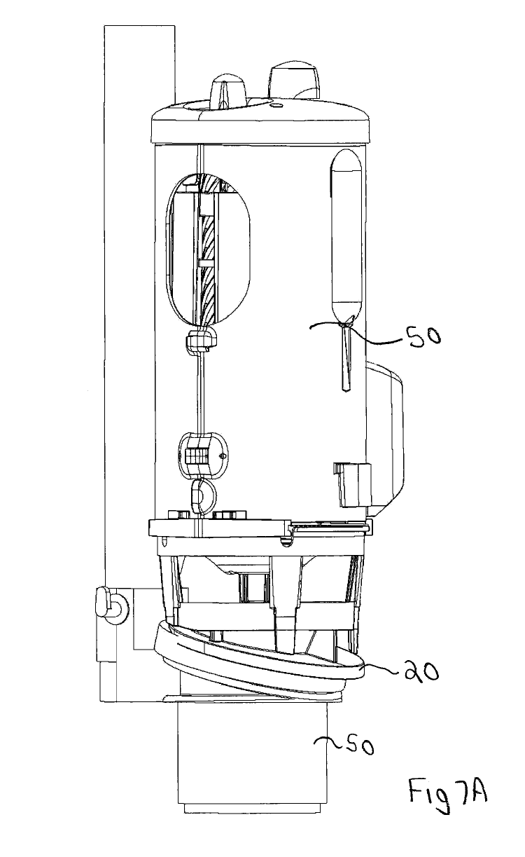

### DETAILED DESCRIPTION OF THE DRAWINGS

As seen in the attached figures, the present invention provides a toilet valve adapter 10. Adapter 10 includes a hollow body 20 having a lower end 22 dimensioned to be received into a flush valve outlet 40 and an upper end 28 dimensioned to support a flush valve 50 thereon. Adapter 10 further comprises a flange 24 extending radially outwards from hollow circular body 20. Although the present invention can ideally be used with toilet valves, the present invention is not so limited. Instead, it may be used with any suitable valve system.

A gasket 25 is received on the underside of flange 24. In one embodiment, gasket 25 is received within a pocket on the underside of flange 24, as shown. Gasket 25 may optionally be made of an adhesive material, but the present invention is not so limited. Preferably as well, gasket 25 wraps fully (or partially) around hollow body 20. As can also be seen, flange 24 may be disposed at an angle to the ends 22 and 28 of hollow circular body 20. However, the present invention is not so limited. For example, flange 24 may instead be positioned parallel to ends 22 and 28. Different geometries permit the adapter to be used with different tank and flush valve geometries.

Adapter 10 also comprises prongs 26 projecting radially outwards from the lower end 22 of hollow circular body 20. Prongs 26 may optionally be mounted in cut-away sections 27 of the lower end of the hollow circular body (but the present invention is not so limited). The prongs may be a pair of prongs disposed on opposite sides of the hollow circular body, as shown. Optionally, however, the present invention also encompasses variations with more than two prongs. As can also be seen, one side of the lower portion of hollow body 20 has an aperture 21 running axially therealong permitting fluid flow therethrough.

In operation, the user simply pushes adapter 10 down into toilet tank outlet 40. At this time, the prongs 26 will flex inwardly such that they become lodged against the inside of outlet 40, anchoring adapter 10 in position. Preferably, outlet 40 is the bottom flush discharge outlet in a toilet tank. In addition, gasket 25 will be pushed down against the bottom of the toilet tank, thereby sealing against the top of outlet 40. The combined affect of prongs 26 expanding outwards against the interior of outlet 40 and gasket 25 sealing around the top of outlet 40 keeps adapter 20 firmly in position and also prevent water seepage out of the toilet tank. Optionally, gasket 25 may be made from a sticky or adhesive material, but the present invention is not so limited.

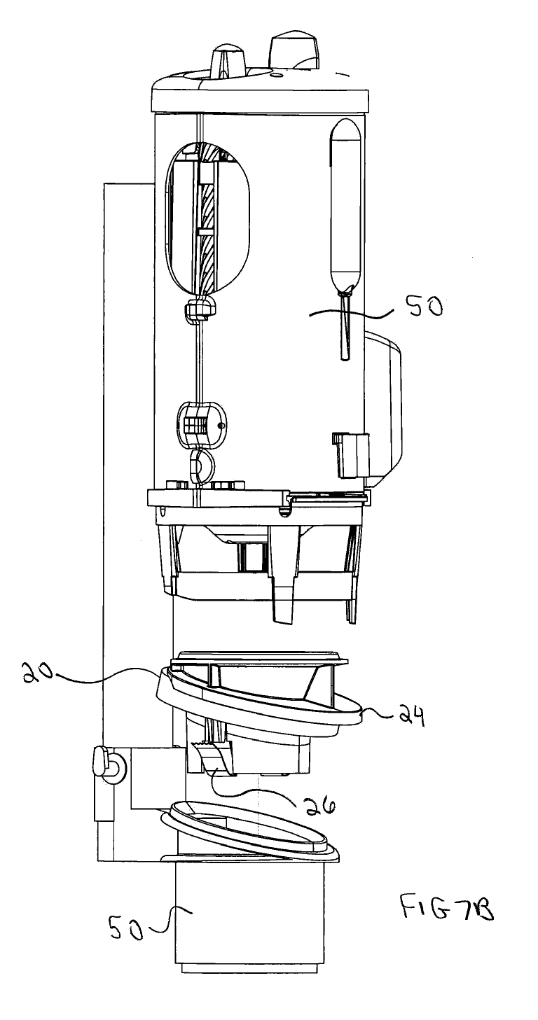

FIGS. 7A and 7B show a preferred embodiment of the invention with adapter 10 shown positioned between the top and bottom halves of a dual flush valve 50.

What is claimed is:

1. A valve adapter, comprising:
a hollow body having a lower end dimensioned to be received into a valve opening and an upper end dimensioned to support a valve thereon;
a flange extending radially outwards from the hollow circular body;
a gasket on the underside of the flange; and
prongs projecting radially outwards from the lower end of the hollow circular body.

2. The valve adapter of claim 1, wherein the gasket is received within a pocket on the underside of the flange.

3. The valve adapter of claim 1, wherein the gasket wraps around the hollow body.

4. The valve adapter of claim 1, wherein the flange is disposed at an angle to the ends of the hollow circular body.

5. The valve adapter of claim 1, wherein the flange is disposed parallel to the ends of the hollow circular body.

6. The valve adapter of claim 1, wherein the prongs are disposed in cut-away sections of the lower end of the hollow circular body.

7. The valve adapter of claim 1, wherein the prongs are disposed on opposite sides of the hollow circular body.

8. The valve adapter of claim 1, wherein one side of the lower end of the hollow body has an aperture running axially therealong permitting fluid flow therethrough.
